(19) United States
(12) Patent Application Publication
(10) Pub. No.: US 2022/0139598 A1
(43) Pub. Date: May 5, 2022

(54) GROMMETS FOR HOLDING CABLES

(71) Applicant: CommScopeTechnologies LLC, Hickory, NC (US)

(72) Inventors: Ronald A. Vaccaro, Taylorsville, NC (US); Aviral Joshi, Chicago, IL (US); Christopher R. Stockman, Bella Vista, AR (US)

(21) Appl. No.: 17/492,868

(22) Filed: Oct. 4, 2021

Related U.S. Application Data
(60) Provisional application No. 63/109,465, filed on Nov. 4, 2020.

(51) Int. Cl. H01B 17/58; F16L 3/12; H01B 3/44

(52) U.S. Cl. CPC H01B 17/583; H01B 3/441; F16L 3/12

(57) ABSTRACT

The present disclosure describes a grommet formed of a polymeric material and adapted for securing a cable within a cable hanger. The grommet includes a main body having a generally cylindrical profile surrounding an interior cavity, the main body further having a length, a thickness, and a longitudinal axis; and two arms extending radially outwardly from the main body, one arm extending from a bottom edge of the main body and the other arm extending from a top edge of the main body, wherein each arm includes a flanged edge configured to engage the cable hanger when an excessive load force is applied to the cable. A grommet including two pairs of arms is also described herein.

### RELATED APPLICATION(S)

The present application claims priority to and the benefit of U.S. Provisional Patent Application Ser. No. 63/109,465, filed Nov. 4, 2020, the disclosure of which is hereby incorporated herein in full.

### FIELD

The invention relates to grommets for holding cables.

### BACKGROUND

Until recently, antenna towers have typically employed RF coaxial cables for power and/or signal communications. Such cables are often mounted to the tower via cable hangers, which capture the cable and mount it to the tower. One popular variety of cable hanger is a “stackable” hanger, which has the capacity to mount via snap latches to another hanger, thereby enabling multiple cables to be mounted in a “stack”; an exemplary stackable hanger is the Snap-Stak hanger, available from CommScope, Inc. (Joliet, Ill.). Snap-in hangers are often desirable due to their ease of use, although cable hangers that are not stackable are often employed also.

Operators have begun to replace traditional RF cables on towers with fiber optic and/or hybrid fiber/power cables. These new cables (especially the hybrid styles) can have a slightly irregular shape. Also, fiber optic and hybrid fiber/power cables are typically heavy (in some instances three to four times the weight per unit length of traditional RF cable). In addition to being of a slightly irregular shape, the diameter over jacket (DOJ) of a cable can be vastly different from traditional RF cables.

As a result, in practice some operators use standard hangers in combination with grommets to hang fiber or hybrid fiber cable. The grommets are a fairly soft polymer (e.g., EPDM, nylon, or the like). The outer diameter of the grommet may be sized to fit in the hanger, whereas the inner diameter is configured to grip the fiber/hybrid fiber cable. However, the grommets may be sized poorly for the cables they receive and/or may slip from the hanger. As such, modifications to improve the holding of cables via such grommets may be desirable.

### SUMMARY

A first aspect of the present invention is directed to a grommet formed of a polymeric material and adapted for securing a cable within a cable hanger. The grommet includes a main body having a generally cylindrical profile surrounding an interior cavity, the main body further having a length, a thickness, and a longitudinal axis; and two arms extending radially outwardly from the main body, one arm extending from a bottom edge of the main body and the other arm extending from a top edge of the main body. Each arm includes a flanged edge configured to engage the cable hanger when an excessive load force is applied to the cable.

Another aspect of the present invention is directed to a grommet formed of a polymeric material and adapted for securing a cable within a cable hanger. The grommet includes a main body having a generally cylindrical profile surrounding an interior cavity, the main body further having a length, a thickness, and a longitudinal axis; and two pairs of arms extending radially outwardly from the main body, one pair of arms extending from a bottom edge of the main body and the other pair of arms extending from a top edge of the main body. Each arm includes a flanged edge configured to engage the cable hanger when an excessive load force is applied to the cable.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1A is a side view of a light or standard duty grommet.

FIG. 1B is a top view of the grommet of FIG. 1A.

FIG. 1C is an exploded perspective view showing the grommet of FIG. 1A in combination with a cable hanger.

FIG. 1D is a side view of the grommet of FIG. 1A in combination with a cable and secured within a cable hanger.

FIG. 2A is a side view of a heavy duty grommet.

FIG. 2B is a top view of the grommet of FIG. 2A.

FIG. 2C is a side view of the grommet of FIG. 2A in combination with a cable and secured within a cable hanger.

FIG. 3A is a side view of a heavy duty grommet according to embodiments of the present invention.

FIG. 3B is a perspective view of the grommet of FIG. 3A.

FIG. 3C is a top view of the grommet of FIG. 3A.

FIG. 4A is an exploded perspective view showing the grommet of FIG. 3A in combination with a cable hanger.

FIG. 4B is a side view of the grommet of FIG. 3A in combination with a cable and secured within a cable hanger.

FIGS. 5A-5C are top views of alternative embodiments of the grommet of FIG. 3A showing different aperture patterns near the inner diameter.

FIGS. 6A-6C are section views of alternative embodiments of the grommet of FIG. 3A showing the depth of apertures such as those shown in FIGS. 5A-5C.

FIGS. 7A and 7B are top views of an alternative embodiment of the grommet of FIG. 3A showing a relaxed condition prior to cable insertion (FIG. 7A) and a flexed condition during cable insertion (FIG. 7B).

### DETAILED DESCRIPTION

The present invention now is described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the figures, certain layers, components, or features may be exaggerated for clarity, and broken lines illustrate optional features or operations unless specified otherwise. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention. The sequence of operations (or steps) is not limited to the order presented in the claims or figures unless specifically indicated otherwise.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

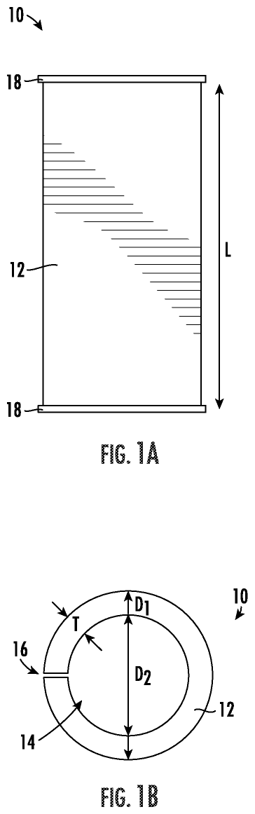

Referring now to the figures, a grommet 10 adapted for use with a cable hanger 50 is illustrated in FIGS. 1A-1D. The grommet 10 shown in FIGS. 1A-1D is sometimes known as a “light” or “standard duty” grommet. Exemplary grommets are described in U.S. Patent Application Publication No. 2019/0345670 to Wang et al. and U.S. Patent Application Publication No. 2020/0041042 to Vaccaro et al., the disclosures of which are hereby incorporated herein in their entireties. The grommet 10 comprises a main body 12 having two ends 18. The main body 12 surrounds an interior cavity 14. The grommet 10 is formed of a polymeric material and is adapted for holding a cable 150 within a cable hanger 100 (FIGS. 1C and 1D). For example, the grommet 10 may comprise rubber (e.g., EPDM), polypropylene, nylon, acetal, acrylonitrile butadiene styrene (ABS), or the like. The main body 12 of the grommet 10 has a length (L), a thickness (T), and a longitudinal axis defined by its length dimension. The main body 12 may have an outer diameter (D₁) and an inner diameter (D₂). The thickness (T) of the main body 12 can be determined by subtracting the inner diameter (D₂) from the outer diameter (D₁) and dividing by two. The diameters (D₁, D₂) of the main body 12 can vary depending on the diameter of the cable 150 being held within the grommet 10.

The main body 12 may have a slot 16 extending along its length (L). The slot 16 provides an entry point for the cable 150 to be inserted into the interior cavity 14. The polymeric material that forms the grommet 10 gives the grommet 10 a certain degree of flexibility, such that the grommet 10 may be deflected to an open position to enable insertion of the cable 150. Once the cable 150 is positioned within the interior cavity 14 of the grommet 10, the resilient nature of polymeric material allows the grommet 10 to recover to its original size, thereby securing the cable 150 within the grommet 10. Exemplary types of cables 150 that may be secured within the grommet 10 include, but are not limited to, fiber optic cables and hybrid fiber/power cables.

The ends 18 of the grommet 10 may protrude from the main body 12 to provide additional stability when the grommet 10 is used with a cable hanger 100 (see, e.g., FIG. 1C and FIG. 1D). However, in some instances, when an excessive (load) force F₁ is applied to (or by) a cable 150 (e.g., the cable 150 is pulled or a heavier weighted cable 55 is used) that is held within the grommet 10 and secured within the cable hanger 100 (e.g., cable hanger assembly 20 shown in FIG. 1D), the small, pliable/flexible protruding ends 18 of the grommet 10 may not provide sufficient support to hold the grommet 10 within the cable hanger 100, and thus, may result in the grommet 10 being pulled away from the cable hanger 100 (i.e., no longer being secured within the cable hanger 100).

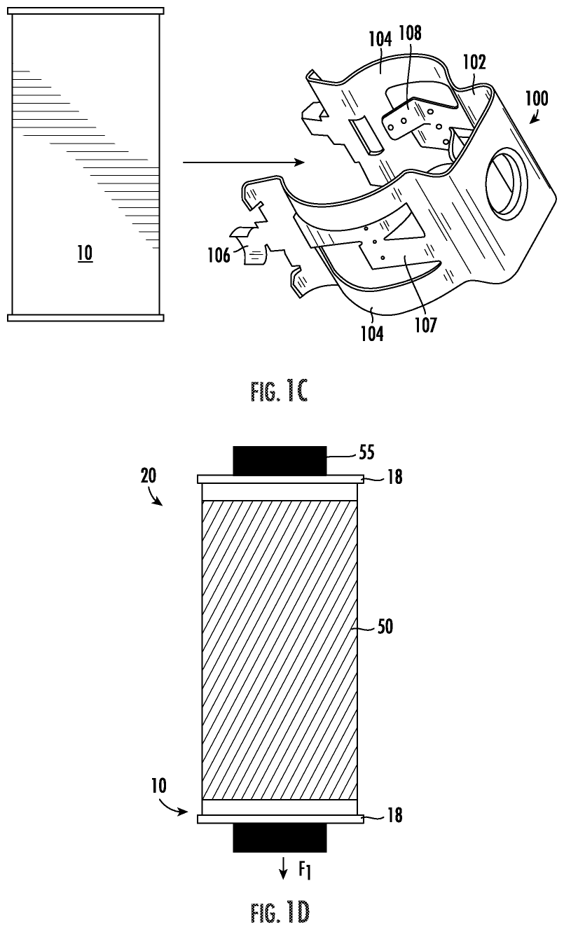

To overcome this potential issue, a grommet 30 illustrated in FIGS. 2A-2C may be used instead of the light or standard duty grommet 10. The grommet 30 shown in FIGS. 2A-2C is sometimes known as a “heavy duty” grommet. Properties and/or features of the grommet 30 may be as described above in reference to the grommet 10 shown in FIGS. 1A-1C and duplicate discussion thereof may be omitted herein for the purposes of discussing FIGS. 2A-2C.

As shown in FIGS. 2A-2C, the grommet 30 differs from grommet 10 in that one of the ends 38 of the grommet 30 includes opposing arms (or “wings”) 38a. Each arm 38a may include a flanged edge 39a extending outwardly and generally parallel to the main body 32 of the grommet 30. As shown in FIG. 2C, when an excessive (load) force F₁ is applied to (or by) the cable 150 held within the grommet 30 and secured within the cable hanger 100 (e.g., cable hanger assembly 40), the flanged edge 39a of the arms 38a are configured to engage an upper edge 100a of the cable hanger 100, thereby preventing the grommet 30 from being pulled from the cable hanger 100. However, as shown in FIGS. 2A and 2C, the arms 38a with the flanged edges 39a only reside at one end 38 of the grommet 30, and the opposing end 38 of the grommet 30 has similar protruding ends 18a as the light or standard duty grommet 10 discussed above (i.e., small and pliable/flexible). Thus, the flanged edges 39a of the grommet 30 are directional in their designed function. In some instances, a technician may install the grommet 30 upside down (i.e., with the flanged edges 39a adjacent to the lower edge 100b of the cable hanger 100), thereby allowing the heavy duty grommet 30 to be just as easily pulled away from the cable hanger 100 as the light or standard duty grommet 10 when an excessive load force F₁ is applied thereto.

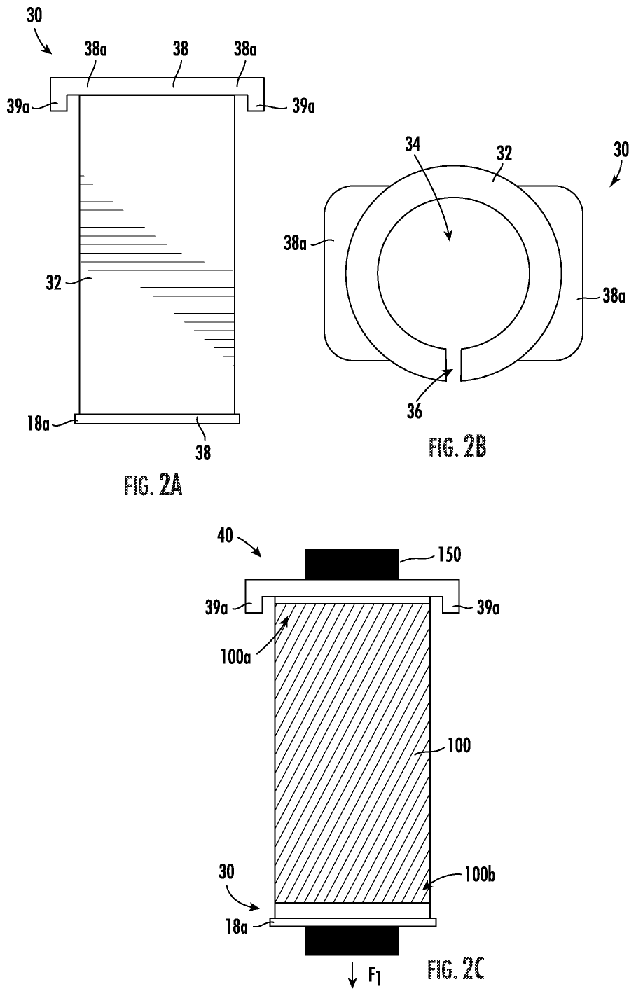

Referring now to FIGS. 3A-3C, a grommet 50 according embodiments of the present invention is illustrated. Properties and/or features of the grommet 50 may be as described above in reference to the grommets 10, 30 shown in FIGS. 1A-1C and FIGS. 2A-2C and duplicate discussion thereof may be omitted herein for the purposes of discussing FIGS. 3A-3C.

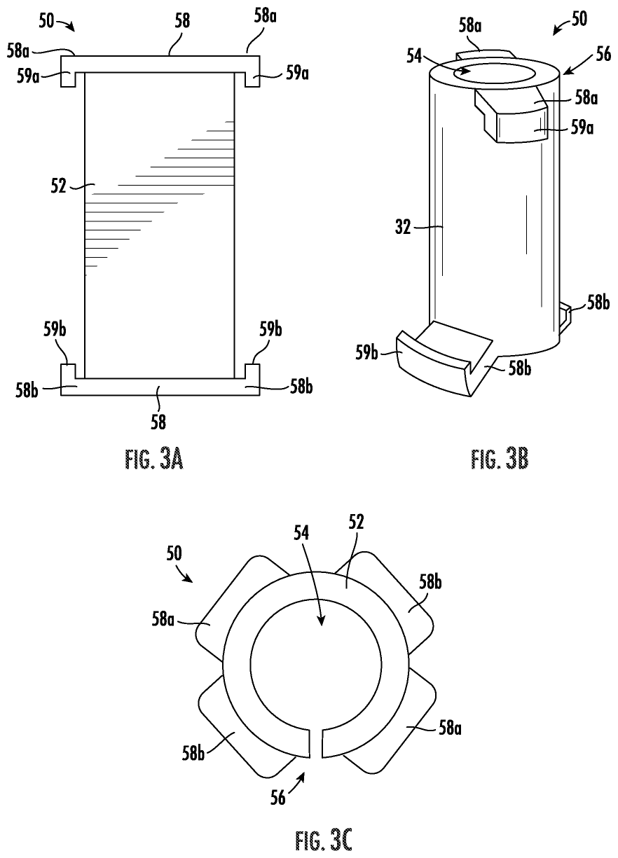

As shown in FIGS. 3A-3C, the grommet 50 differs from grommet 30 (and grommet 10) in that both ends 58 of the grommet 50 include opposing arms (or wings) 58a, 58b that extend radially outwardly from the ends 58 of the grommet 50, i.e., top arms 58a and bottom arms 58b. In some embodiments, each arm 58a, 58b may include a flanged edge 59a, 59b. The flanged edges 59a, 59b extend downwardly and generally parallel to the main body 52 of the grommet 50, i.e., the flanged edges 59 of the top arms 58a extend downwardly and the flanged edges 59b of the bottom arms extend upwardly. Similar to the grommet 30 described above, as discussed further below, the flanged edges 59a, 59b of the grommet 50 are configured to engage respective upper and lower edges 100a, 100b of a cable hanger 100, thereby preventing the grommet 50 from being pulled from the cable hanger 100 in either direction (see, e.g., cable hanger assembly 60 in FIG. 4B). The arms 58a, 58b (and flanged edges 59a, 59b) of the grommet 50 allow the grommet 50 to resist an excessive force (e.g., load) F₁, F₂ from either direction (i.e., non-directional assembly) (see, e.g., FIG. 4B), and enable a technician to install the grommet 50 either “upside-down” or “right-side-up” without impacting the effectiveness of the grommet 50 in holding cable.

As shown in FIGS. 3B and 3C, in some embodiments, each of the top arms 58a and each of the bottom arms 58b are spaced apart by approximately 180 degrees. However, while adding a second set of arms (i.e., bottom arms 58b) to the grommet 50 solves the problem of the grommet 50 being pulled away from a cable hanger 100 when the grommet 50 is installed upside down, the grommet 50 may prove to be difficult and expensive to manufacture because each pair of arms 58a, 58b of the grommet 50 may not provide enough clearance when the two halves of the mold forming the grommet 50 separate. Thus, as shown in FIGS. 3B-3C, according to some embodiments of the present invention, the top arms 58a are circumferentially staggered or offset from the bottom arms 58b. By staggering the arms 58a, 58b of the grommet 50, during manufacturing, the mold halves forming the part may separate without being obstructed by the arms 58a, 58b at the opposite end of the grommet 50, thereby making manufacturing the grommet 50 easier and less expensive.

Referring to FIGS. 4A-4B, and as discussed herein, the grommet 50 may be used in combination with a cable hanger 100. Coaxial cables for power and/or signal communications are often mounted to a foundation structure, e.g., an antenna tower, via cable hangers 100, which capture the cable 150 and mount it to the structure. The cable hanger 100 may include a generally C-shaped body 102 having two opposable arms 104. The opposable arms 104 may have latches 106 that extend away from the cable hanger body 102. In some embodiments, the cable hanger 100 may be dimensioned to receive the grommet 50 of the present invention such that the grommet 50 can be held between the opposable arms 104 of the cable hanger 100, with the flanged edges 59a, 59b engaging the upper and lower edges 100a, 100b of the cable hanger 100. Some cable hangers 100 may have flex members 107 with gripping members 108. In some embodiments, the main body 52 of the grommet 50 may have at least one groove or indention (not shown) configured to allow the gripping members 108 of the cable hanger 100 to grip onto the grommet 50, thereby further securing the grommet 50 within the cable hanger 100. Exemplary cable hangers are shown in U.S. Pat. No. 9,306,380 to Vaccaro, U.S. Pat. No. 9,866,004 to Vaccaro et al., and U.S. Pat. No. 9,903,510 to Joshi et al., each of which are incorporated by reference in their entirety herein. The combination of the grommet 50 and cable hanger 100 can be mounted to the foundation structure via the latches 106.

In some embodiments, the main body 52 of the grommet 50 may have a generally cylindrical profile that surrounds the interior cavity 54. In some embodiments, the main body 52 may have a profile shape other than cylindrical, for example, the main body 52 may be hexagonal, square, oval, oblong, etc. in profile. The main body 52 of the grommet 50 is typically sized such that its outer diameter fits snugly within the cable hanger 100, and thus may be slightly larger than the inner diameter of the cable hanger 100. The inner diameter (D₂) of the main body 52 of the grommet 50 is sized to capture a cable 150. In some embodiments, the main body 52 has an inner diameter (D₂) from about 0.1 inches to about 10.0 inches. In some embodiments, the main body 52 has an outer diameter (D₁) from about 0.1 inches to about 10.0 inches. In some embodiments, the main body 52 can have a length (L) from about 0.1 inches to about 10.0 inches.

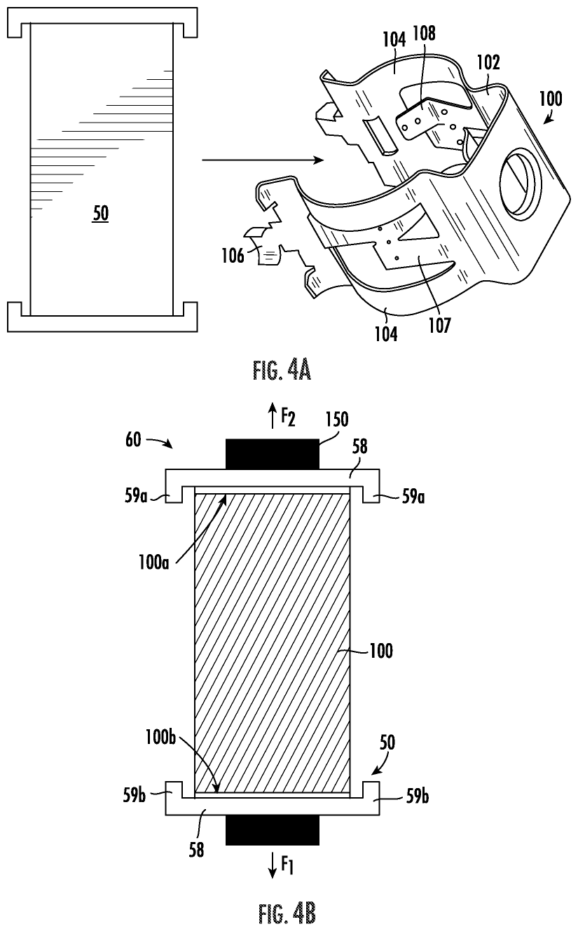

Because the cables 150 held by the grommet 50 may be of irregular cross-sectional shape, one of the characteristics of the grommet 50 may be desirable in some embodiments is a sufficiently low hardness that the inner diameter of the grommet 50 can conform to irregularities. However, employing a material of lower hardness may produce a grommet 50 that is sufficiently soft that its ability to remain snugly within the cable hanger 100 is impaired. To address this potential issue, the grommet 50 may include “softening” apertures near the inner diameter that can effectively increase the “give” of the inner diameter of the grommet 50. Exemplary aperture patterns include a single ring of holes 70 (FIG. 5A), a series of elongate slots 72 (FIG. 5B) and multiple rings of staggered holes 74 (FIG. 5C). See also, e.g., U.S. Pat. No. 9,306,380 to Vaccaro, the disclosure of which is hereby incorporated herein in its entirety. Other shapes, sizes and/or patterns of holes may also be employed, or the holes may be omitted in some embodiments.

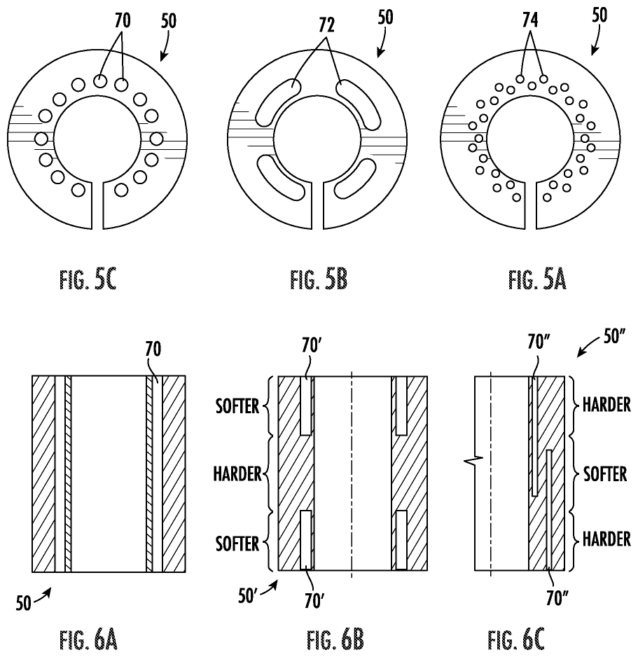

FIG. 6A illustrates that the “softening” apertures 70, 72, 74 shown in the grommets 50 of FIGS. 5A-5C extend through the entire thickness of the grommet 50. In some embodiments, the softening apertures may extend through only a portion of the thickness of the grommet 50, with the result that the hardness of the inner diameter of the grommet 50 may vary along its thickness (T). FIG. 6B illustrates a grommet 50′ with apertures 70′ that extend only partially into the thickness of the grommet 50′ such that a middle portion of the grommet 50′ has no apertures, with the result that the upper and lower ends of the grommet 50′ are effectively softer than the middle portion. FIG. 6C illustrates a grommet 50″ with apertures 70″ that also extend only partially into the thickness of the grommet 50″, but such that the apertures 70″ overlap in the middle portion of the grommet 50″, with the result that the middle portion of the grommet 50″ is softer than the ends. Other arrangements of apertures may also be employed, or in some embodiments, the apertures may be omitted entirely.

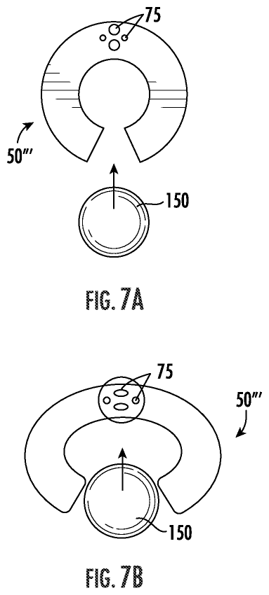

FIGS. 7A and 7B illustrate a grommet 50′″ that includes flexing apertures 75 at the central portion of the arc described by the “C” of the grommet 50′″. The flexing apertures 75 are positioned to enable the grommet 50′″ to flex more easily due to the absence of material at the flexure location; thus, during the insertion of a cable 150 (as shown in FIG. 7B), the “arms” of the grommet 50′″ can separate to facilitate the entry of the cable 150 into the grommet 50′″. Those of skill in this art will recognize that other sizes, shapes, and/or patterns of flexing apertures may be employed, or flexing apertures may be omitted entirely.

In some embodiments, the grommet 50 of the present invention may further include one or more “ribs” extending radially outwardly from the main body 52 of the grommet 50. The ribs may help to further secure the grommet 50 within a cable hanger 100. The rib(s) may extend circumferentially or axially on main body 52. Those skilled in the art will recognize that the grommet 50 may have more or fewer ribs (which may depend on the configuration of the cable hanger being used), or may lack ribs entirely.

In some embodiments, the grommet 50 of the present invention may include one or more interior ribs or flaps that extend radially inwardly into the cavity 54 of the grommet 50. In some embodiments the interior ribs or flaps may have a frustoconical shape. The ribs or flaps may extend around the inner circumference of the grommet 50. The interior ribs may be designed to compress or collapse around a cable 150 when a larger size cable 150 is placed into the cavity 54 of the grommet 50, securing the cable 150 within the grommet 50. Exemplary grommets having interior ribs or flaps are described in U.S. Pat. No. 9,407,078 to Budagher et al., the disclosure of which is hereby incorporated herein in its entirety.

In some embodiments, instead of having a single interior cavity 54, the grommet 50 of the present invention may have multiple “cavities” or holes, each configured to hold and secure a respective cable 150 therein. Each cavity has a respective slot that allows the cable 150 to be inserted. In some embodiments, the slots may extend from an outer surface of the grommet 50 to a respective cavity and/or the slots may extend between adjacent cavities. The diameters of each cavity may vary such that the grommet 50 can accommodate different sized cables 150. Exemplary grommets having multiple holes are the multi-hole hanger inserts manufactured by MIROC (Albuquerque, N. Mex.).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

1. A grommet formed of a polymeric material and adapted for securing a cable within a cable hanger, comprising:
a main body having a generally cylindrical profile surrounding an interior cavity, the main body further having a length, a thickness, and a longitudinal axis; and
two arms extending radially outwardly from the main body, one arm extending from a bottom edge of the main body and the other arm extending from a top edge of the main body, wherein each arm includes a flanged edge configured to engage the cable hanger when an excessive load force is applied to the cable.

2. The grommet of claim 1, wherein the grommet comprises two pairs of arms extending radially outwardly from the main body, one pair of arms extending from a bottom edge of the main body and the other pair of arms extending from a top edge of the main body.

3. The grommet of claim 1, wherein the position of the top arm on the top edge of the main body is circumferentially spaced apart approximately 180 degrees relative to the position of the bottom arm on the bottom edge of the main body.

4. The grommet of claim 2, wherein the arms of each pair are spaced apart approximately 180 degrees, and wherein the position of the top pair of arms on the top edge of the main body is circumferentially staggered relative to the position of the bottom pair of arms on the bottom edge of the main body.

5. The grommet of claim 1, wherein the polymeric material comprises rubber or polypropylene.

6. The grommet of claim 1, in combination with the cable, wherein the cable resides within the interior cavity of the main body.

7. The grommet of claim 6, wherein the cable comprises a cable selected from a group consisting of fiber optic cables and hybrid fiber/power cables.

8. The grommet of claim 1, in combination with a cable hanger, wherein the cable hanger has opposable arms, and wherein the grommet is held between the opposable arms.

9. The grommet of claim 1, wherein the main body has a length from about 0.1 inches to about 10.0 inches.

10. The grommet of claim 1, wherein the main body has an inner diameter from about 0.1 inches to about 10.0 inches and an outer diameter from about 0.1 inches to about 10.0 inches.

11. The grommet of claim 1, wherein the main body further includes a plurality of apertures extending generally parallel to the longitudinal axis of the main body, wherein at least some of the plurality of apertures extend less than the length of the main body.

12. The grommet of claim 11, wherein the plurality of apertures comprises a first set of apertures that extend into the main body from an upper surface of the main body and a second set of apertures that extend into the main body from a lower surface of the main body.

13. The grommet of claim 12, wherein the first set of apertures does not overlap with the second set of apertures.

14. The grommet of claim 12, wherein the first set of apertures overlaps with the second set of apertures.

15. The grommet of claim 11, wherein the apertures are non-circular in cross-section.

16. A grommet formed of a polymeric material and adapted for securing a cable within a cable hanger, comprising:
a main body having a generally cylindrical profile surrounding an interior cavity, the main body further having a length, a thickness, and a longitudinal axis; and
two pairs of arms extending radially outwardly from the main body, one pair of arms extending from a bottom edge of the main body and the other pair of arms extending from a top edge of the main body, wherein each arm includes a flanged edge configured to engage the cable hanger when an excessive load force is applied to the cable.

17. The grommet of claim 16, wherein the arms of each pair are spaced apart approximately 180 degrees, and wherein the position of the top pair of arms on the top edge of the main body is circumferentially staggered relative to the position of the bottom pair of arms on the bottom edge of the main body.

18. The grommet of claim 16, in combination with the cable, wherein the cable resides within the interior cavity of the main body.

19. The grommet of claim 16, in combination with a cable hanger, wherein the cable hanger has opposable arms, and wherein the grommet is held between the opposable arms.

20. The grommet of claim 16, wherein the main body further includes a plurality of apertures extending generally parallel to the longitudinal axis of the main body, wherein at least some of the plurality of apertures extend less than the length of the main body.
